(19) United States
(12) Patent Application Publication
(10) Pub. No.: US 2014/0042064 A1
(43) Pub. Date: Feb. 13, 2014

(54) Ecological Biotope Water Purification System Utilizing a Multi-Cell and Multi-Lane Structure of a Constructed Wetland and Sedimentation Pond

(71) Applicant: Chanwoo Byeon, Seongnam (KR)

(72) Inventor: Chanwoo Byeon, Seongnam (KR)

(21) Appl. No.: 14/112,925

(22) PCT Filed: Jun. 19, 2012
(86) PCT No.: PCT/KR12/04844

§ 371 Date: Oct. 19, 2013

Related U.S. Application Data
(63) Continuation of application No. PCT/KR2012/004844, filed on Jun. 19, 2012.

(51) Int. Cl. C02F 3/32

(52) U.S. Cl. CPC C02F 3/327
USPC 210/170.01

(57) ABSTRACT

The present invention provides an ecological biotope water purification system utilizing multi-cells and multi-lanes by considering the width, length, curvature and slope of proposed composition site wetland and pond. The system comprising: a sedimentation pond (200, 200′) for temporarily storing wastewater incoming from an Inlet (100,100′); a marsh (300, 300′) incoming the primarily treated water, being precipitated solid contaminants, and discharged from the sedimentation pond (200, 200′), and at least one Multi-level cell composed an open water-surface pond (400, 400′) entering the primarily treated water from the marsh; a settling reservoir (600, 600′) outflow finally purified water by multi-level cell inflow for temporarily storing through outlet (700, 700′), the multi-level cell consists at least of two multi-lanes (40, 40′, 40″), each lane is separated by small dikes (900, 900′). The present invention has advantage to compose the suitable wetland and pond on the proposed land by considering the geographic situation of site width, length, curvature and slope. Thus, it is possible to maximize the flexible design.

### BACKGROUND OF THE INVENTION

1. Field of the Invention

The present invention relates to an ecological biotope water purification system utilizing the structure of a constructed wetland and the sedimentation pond for naturally purifying the wastewater. More particularly, the ecological biotope water purification system utilized the multi-cell and multi-lane structure of the constructed wetland and sedimentation pond has adopted for purifying the wastewater and enhancing bio-diversity.

2. Related Prior Art

The ecological Biotope water purification system is a multi-stage cell of the constructed wetland for treating the point- or non-point source of contaminants occurring in the watershed during the initial rainfall.

The wetlands, which are mainly used to treat the contaminated water, are the natural wetland and the artificial wetland. The constructed wetland is divided into two different types; one is the free water level wetland and the other is the underground flow wetland. The constructed wetland could be built by imitating the natural wetland treatment system. However, unlike the natural wetland, the constructed wetland is possible to construct in almost any place. In both cases, a pretreatment process is required to reduce inflow of the solid material into the wetland system.

The free water surface type wetland cell is designed in the form of a pond or waterway, which is provided with a soil layer or a media where the plants can grow. The water is generally treated the ordering process. The influent water to be treated flows on the surface of the soil layer to maintain a shallow water layer. The construction of the free water surface wetland is inexpensive and no clogging, so that it is suitable to be built in almost any place.

The free water surface type constructed wetland system has a high applicability for the domestic or rural areas for a point contaminant source and a non-point contaminant source, simultaneously. The wetland can be divided into three types: the shallow marsh wetland type, the pond-wetland type and the extended detention wetland type depending on the component, depth, area, and placement. Most of the inflow forms retention in the shallow marsh type wetland and the deep point of the water forms the reservoir (forebay) and sedimentation (micropool). The shallow marsh type wetland provides an excellent habitat for wildlife. However, the shallow marsh type wetland requires a wide area of land compared to the other type and continuous inflow. The pond-wetland type forms the deepest water compared to other types. Moreover, the pond occupies half the capacity of the processed water. The pond-wetland type has less value as a wildlife habitat compared to a shallow marsh type wetland. But, due to the multi-step processing, the pond-wetland type has less requirements for the composing site. The extended detention wetland type is the transformation of the shallow marsh wetland type. It is possible to maintain normal level of water retention for the above, so that the extended detention wetland type has effect, not only on the basic long-term reservoir sedimentation and the biological treatment capabilities, but also on flow reduction and the flood control, etc.

Accordingly, the constructed wetland is required to have the economical value, and easily maintain a highly efficient water purification facility to cleanse the point contaminant source and the non-point contaminant source. It will also provide a good looking landscape, improving the biodiversity and providing space for treating the water. The constructed wetland will also provide a site for efficient water purification system, an ecological education place and a local community space.

Moreover, the necessity of constructed wetland is emerging, which shows self-performance is easy to maintain, easy to afford and is highly economical. The solar energy is the main power source. The organic material is the major subject to purify. A separate supply of purification material is not required. The complex ecological mechanism of the wetland has a capability to convert the toxic organic compounds and the metallic materials to biologically stable compounds. The constructed wetland can treat most pollutants such as urban sewage, industrial wastewater, non-point contaminant source during storm water rainfall and heavy metals. The constructed wetland has a higher applicability, as well as the ecological landscape in harmony with the surrounding environmental space having the function of a habitat for enhanced biodiversity. The ecological environment provides the educational space and a recreation area for the residents and visitors.

In the existing system adopting the wetland, the vegetation is densely grown. The cells are arranged in parallel or in series to form a simple system. In recent years, a batch configured system is introduced that a pond and a vegetating wetland are properly mixed. But, the existing system is designed and constructed mainly for the water treatment. Neglecting a habitat for wildlife and the environmental education place.

So far, the water purifying system using constructed wetland has disclosed the Republic of Korea Patent No. 220403 and the Patent Publication No. 2000-72363.

FIG. 1 is the first conventional wastewater treatment system using marsh return-wetland. The sewage contained the eutrophication substance, such as nitrogen and phosphorus, is treated by the micro-organism and the wetland plants, as the intensive sewage treatment plants. A certain amount of the wastewater discharged from a septic tank (1) flows into the sewage trench (3), which is controlled by the flow rate adjustment tank (2). Under the anaerobic condition, the odor compound is decomposed by the anaerobic microorganism in the trench (3). The organic matter is decomposed by the aerobic microorganisms that inhabit on the crushed stone in the decomposing tank (4). The organics decomposed in the decomposing tank (4) will be removed by absorbance through the buttercup growing in the wetland (5). The treated water discharged from the marsh wetland (5) will be stored in the pond (6). The treated water in the pond (6) is returned to the water adjustment tank (2) by the first returns pipe line (8) and the first return pump (7). The sediment in the pond (6) is returned to the septic tank (1) through the second return pipe line (8′) and a second return pump (7′). The extra line is a bypass pipe line (9).

FIG. 2 is the second conventional technology using the wetland to promote the natural cleansing device that the wastewater is purified by a natural purification method. The constructed wetland for promoting the method of natural purification and its facility shows that a detention is installed for composing the wetland and supplying the air to promote a natural purification.

The configuration is that; at a certain position of the existing channel (11), an inlet pipeline (22) of the water distribution tank is connected to the inlet pipe sluice (23), which is formed sidewalls at a certain position of the rainfall chamber (21); the wastewater flows along the inlet pipeline (22) of the water distribution tank from the rainfall chamber (21) to the water distribution tank (24); from the water distribution tank (24), the settling tank connector (26) is connected to the settling tank manhole (25); the purified water flows to the sedimentation manhole (25), then cleaned water discharges to the channel (11) through the water pump (47), while the water pumped-up by the water pump (47) flows along the pump discharge pipe line (48) back to the water distribution tank (24), then the water flows along the inflow pipe line (27) flows to the wetland inlet manhole (28); the incoming water flows again along the inflow pipe line (27) back to each sector of the wetland area (41a) (41b) (41c); a certain marsh area of the wetland causes pests, such as a mosquito, so that the pond (45a) is composed as of habitat for mosquito larvae-eating loach, frog, etc.; on the outskirts of the wetland area, a blower fan (44a) is installed in a machine room (44) to inlet the air through the air discharging pipe (44b), which is installed under the filter layer of the wetland at certain intervals: the wetland area (41a) (41b) (41c) forms the sand filter layer (42), which consists of a large gravel, small pebbles, large grain of sand, sand, and the aquatic plants are growing in the constructed wetland for promoting a natural-cleansing device.

However, all of these methods have to use complex machinery, only considering the function due to the space efficiency. Therefore, it is hard to consider a site specific ecosystem and landscape as well. Both of the point and non-point contaminant sources are inadequately treated, in fact.

In order to solve the above problems, the inventors have disclosed and patented that; the Republic of Korea Patent No. 444972 “the system and method of multi-level cell, constructed wetland for treating the point and non-point contaminant sources for utilizing a good ecological park. In other words, the third conventional technology tries to solve the problems of first and second conventional technologies through the constructed wetland without any mechanical device needed for purifying the wastewater by using the natural purifying system. It has considered the landscaping and designed for maximizing the space efficiency by introducing the multi-level cell for treating the contaminant source.

In particular, the wetland construction site has natural ecological factors (hydrology, water quality, as well as topography, geology, vegetation, climate, etc.), which has to be analyzed, and considering them as much as possible to improve the efficiency of space management. The construction site must be considered, not only the landscaping for ecological park, but also serving as a multi-level cell constructed wetland to provide a treatment system for contaminant source, simultaneously.

Referring to FIGS. 3 and 4, the third conventional technology describes in detail that the wetland is composed of the inlet (100) facing to the Marsh (300), the water flow control tank (310) and the outflow side marsh contacting with the pond and outlet.

The marsh can be defined as a space having a shallow water level, which has a water depth of 10˜40 cm range, densely growing aquatic plants and the treatment capacity of wastewater as a function of BOD, SS, metallic material, pathogens, complex organics, ammonia, mineralization.

Meanwhile, the pond has mostly grown the submerged plants and the duckweeds. The pond has the adequate water depth range of 0.75-1.5 m. The pond is served to reduce the BOD, mainly activate removal functions of the nitrate and phosphate, and respond with atmosphere for delivering oxygen by photosynthesis of the submerged plant and algae and reducing the odor and pests.

The third conventional technology introduces the multi-level cell for treating the pollutant sources by adopting the concept of the constructed wetland system. The sedimentation pond (200) is temporarily storing the wastewater, which is flowing in from the inlet (100). The solid contaminant sink down in the sedimentation pond and the good grade of water is discharged from the primary marsh (300) (referring the first cell). The primarily treated water from the primary marsh flows to the open water surface pond (400). The secondary marsh (500) having same function of the primary marsh that flows in the secondarily treated water from the primary marsh (500) (referring the second cell). The finally purified water from the second marsh is temporarily stored to flow off the settling reservoir (600) through the outlet (700). It is possible to add the third and fourth marshes after the second marsh to compose the multi-level cells.

The sedimentation pond (200) has the pre-treatment facility for separating the solid-liquid by natural gravity precipitation before entering the wetland. The main target of the removal contaminant is the particulate solids. When it is rainfall, the initial wash-off contains a heavy load of contaminants. The rainfall flow speed is gradually reduced and stagnates for a while in the pond. The adequate depth of pond is 1.2˜1.8 m. The suitable surface area of the pond is 5˜15% of the total wetland area. It is desirable to have the introduction plants, such as a common reed, a loosestrife, a willow herb, a starwort, a pussy willow, withy, etc. surrounding the sedimentation pond, and it is suitable to have a bulrush, Erlian, Yellow air leon, a yellow iris, a starwort etc. around boundary of the pond.

Next, the primary wetland (300) is basically adopting the free surface type (FWS) wetland. Here, the pollutants will be treated by deposition, absorption, decomposition, denitrification by the vegetation and microbes. The wetland has to have a long falling distance, a constant width, and placed 2-3 flat-bottom cells or more multi-level cells, and structure of the flat floor in order to the influent flows evenly. The slope of the wetland will be above 1:2.5 for increasing the effectiveness of the ecological trend; waterproofing the ground when it is needed; excavating a certain depth for composing the wetland; the extra soil embank the height of constructed hill; constructing a road or composing the artificial islands (800) for increasing the ecological effects; some loamy soil is suitable to use for planting base. The planting loamy soil is suitable for planting base to lay about 0.45˜0.60 m; the adequate slope of wetland bottom is 0.05%; the suitable depth is 0.2˜0.4 m. At the start and distal parts of the cell, a ware (210) is installed to adjust the water flow rate and water level. The flow adjustment tank (310) is preferably installed in the middle part of the cell. The plants, such as parsley, dalppuri pools, reeds, cattails baby, line, etc. is suitable for purifying the water.

Now, the purified water leads to the pond (400) through the primary wetland. The pond is the open surface water functioning as the water level adjustment and enhancing the nitrification through oxygen supply. In addition, the smooth supply of oxygen, ammonia is transformed to nitrate, and precipitating phosphate. It provides a habitat to the wildlife, such as fish, birds to prevent breeding pests such as mosquitoes. In terms of hydraulics, the mixed batch functions of controlling the water flow rate, increasing the staying time and growing place of the vegetation provide various landscapes. Digging deeper than the floor of wetland to maintain the depth of 0.6˜0.8 m, and the surrounding of pond composes modest slope, so that it can be growing various vegetation. The introductory plants at the edge of the pond are desirable a triangular-bulrush, nymphoides-indica, yellow nymphoides-indica, yellow iris, elecampane, etc. Preferably, the introduced plants surrounding of the pond plants are suitable the common reed, loosestrife, hair loosestrife, starwort, pussy willow, willow, etc.

The second or more multi-level cell marsh (500) provides the same function as the primary marsh (300), which the treated water through the opened water surface arrives in the second marsh.

In addition, the second pond (400′) having same function as the first pond (400), the third wetland (500′) having same feature as the second wetland (500), and the third pond (400″) and the fourth wetland can be added to compose the multi-level cells.

The purified water passing the last marsh leads to the settling reservoir (600). Here, it will prevent to re-buoyant the suspended solids and provides the oxygen supplying capability. The water depth is more than 1.0 m to provide a wide range of plant and animal habitats. The edge of the sedimentation pond has installed a ware to adjust the overall residence time in the marsh. The area is preferably 5˜15% of the total area of the wetland. Around the wetland, introduced plants are least suitable the common reed, loosestrife, hair loosestrife, starwort, pussy willow, willow, etc.

FIG. 4 is aforementioned sectional view of FIG. 3 of the standard components, (a) and (b) are examples of cross-sectional views of wetland having second, third or more multi-level cells for purification.

Some sort of the plants to be planted in the domestic case of the wetland have to consider the treatment efficiency and high applicability. Suitable plants are reeds, cattails baby, line, dalppuri pools, buttercup, etc. Because the dalppuri pools and the buttercup are grown in the shallow water, these plants must be placed in the first level when the multi-level cell is composed. The cattails baby is grown in the deep water possibly survive up to 70 cm depth. Accordingly, the plants are recommended to place the order of [the dalppuri pool, Buttercup]—[Reed, Line]—[baby units]

The Clean Air Act of pests, such as ‘Air-gulping mosquito’, ‘Gambusia affinis’ uses the fish as predator of the mosquito. The impurities, such as the trash in the spring should be managed to avoid floating on the water by keeping higher water level (deep flooding). In the wetland, the stagnant water should be drained periodically (for example, 5 days interval) to prevent the pest, so that the stagnant water level will be lower before the larvae of mosquitoes grown to be adults. Using the behavior of the female mosquito reluctant to lay eggs in the shade, it is suitable to create the shade on the water surface to prevent the mosquito laying eggs.

The 3rd conventional technology has introduced a constructed wetland system applying the multi-level cells for treating a pollutant source and the method of pollutant treatment. The pretreated water goes through the tertiary treatment for cleaning the non-point pollution source in the rural and urban areas. The land on the river uses for re-utilizing the purified river water and re-discharge the re-purified water.

However, more than the 3rd conventional technology, the composing site of the wetland should consider the geographical width, length, curvature and slope. Due to the variability of the given geographical condition, there are many difficulties in design. In some case, the width of the site is too narrow to compose a marsh, pond or sedimentation pond. In the opposite case, the proposed land is too wide or steep to compose a natural looking marsh, pond or sedimentation pond.

The Republic of Korea Patent No. 444972 discloses the “Good ecological park utilize a constructed wetland systems composing a multi-level cell for treating the point and non-point pollutant sources” and the method of same.

### SUMMARY OF THE INVENTION

The purpose of the present invention is to solve the aforementioned problems. An ecological biotope water purification system of multi-cell and multi-lane is developed to compose wetland, pond and sedimentation pond in a suitable location regardless of the width, length, curvature and slope of the proposed land.

The objective of the present invention is to achieve the first aspect of the ecological biotope water purification system utilizing a multi-cell and multi-lane, the system comprising that: a sedimentation pond (200, 200′) for temporarily storing wastewater incoming from an Inlet (100, 100′); a marsh (300, 300′) incoming a primarily treated water, which is precipitated solid contaminants, and discharged from the sedimentation pond (200, 200′), and at least one Multi-level cell composed of an open water-surface pond (400, 400′), which is entering the primarily treated water from the marsh; a settling reservoir (600, 600″) outflow of finally purified water by the multi-level cell inflow for temporary storage through the outlet (700, 700′); and the multi-level cell is consisted at least two of multi-lanes (40, 40′, 40″), each lane separated by small dikes (900, 900′).

Preferably, the multi-lanes are divided by distribution unit (220) to the sedimentation pond (200) and the small dike (900, 900′) from single-channel (30).

Preferably, the multi-lane consists of three multi-lanes. Furthermore, the multi-lanes are joined by joint division (620) to be connected by a settling reservoir. (600).

Preferably, the multi-lanes are further composed from the separate sedimentation pond (200, 200′) being divided by a small dike (900, 900′).

Preferably, the multi-lane is separately connected to each settling reservoir (600).

Preferably, the multi-cells of the marsh and ponds are formed in S-shape curvatures, repeatedly to comply with the terrain.

Preferably, the first marsh incoming water is gradually purified and treated by the multi-level cell being connected to second or more multi-levels, including second marsh (500) composing second or more multi-level cells, which are acting same as the first marsh.

Preferably, the multi-level cell includes at least one of the ecological water purification media (SSM) (32, 33, 35).

Preferably, at least one of the multi-level cells includes a gabion (38).

Preferably, the multi-level cell includes paired gabion (38) being edge overlapped each other in transverse direction for purifying water, and a fishing waterway with a filtering means (150) being installed between the overlapping gabion for filtering the floating.

According to the ecological biotope water purification system adopting the multi-cell and multi-lane of the present invention, there is an advantage to compose a suitable wetland and pond on the proposed land by considering the geographic situation of site width, length, curvature and slope. Thus, it is possible to maximize the flexibility of design.

Additionally, the two or more separated lanes are processing the water treatment; it is possible to maximize the efficiency of purification compared to the same area. The small embankment can be utilized as a road and landscape. Thus, concerning the management and the natural landscaping, the multi lane has the advantage and is more superior to the existing single lane.

Moreover, it is possible to pursue the ecological varieties, if each lane has different plant habitat and animal habitat. If each lane has formed the different characteristics, at least it is possible to process the water purification under particular conditions, such as drought or flood and other situations. It has additional benefit that can be achieved.

In addition, other objectives and benefits of the present invention, it will become apparent through the detailed description of embodiments with attached drawing.

### BRIEF DESCRIPTION OF THE DRAWINGS

FIG. 1 is the first conventional technology of the sewage treatment system using the returned wetland.

FIG. 2 is the second conventional technology of the natural purification promotion system using artificial wetland.

FIG. 3 is a plan view showing the third conventional technology of the constructed wetland with the multi-level cell.

FIG. 4 is a cross-sectional view of FIG. 3, standard ingredients, (a) is a cross-sectional view of the second purification wetland, (b) is a cross-sectional view of the third purification wetland.

FIG. 5a and FIG. 5b are the plan view of first embodiment of an ecological biotope water purification system according to the present invention.

FIG. 5a is a plan view of the upstream of the ecological biotope water purification system.

FIG. 5b is a plan view of the downstream of the ecological biotope water purification system.

FIG. 5c is a cross-sectional view of V-V in FIG. 5b.

FIG. 6 is a plan view showing the different confluence of each lane of the ecological biotope water purification system according to the present invention.

FIG. 7a is a plan view showing each lane having both straight and curve section of the ecological biotope water purification system according to the present invention.

FIG. 7b is a cross-sectional view of VII-VII in FIG. 7a

FIG. 8 is a plan view showing each lane forming a meandering shape of the ecological biotope water purification system according to the second embodiment of the present invention.

FIG. 9 is a bird eye view of the ecological biotope water purification system according to the second embodiment FIG. 8 of the present invention

FIG. 10 is a cross-sectional view of X-X in FIG. 8

FIG. 11 is a cross-sectional view of XI-XI in FIG. 8

FIG. 12 is a plan view showing each lane forming the meandering shape with the sedimentation pond and the settling reservoir of the ecological biotope water purification system according to the present invention.

FIG. 13 is a plan view showing third embodiment of the ecological biotope water purification system with three lanes according to the present invention.

FIG. 14 is a bird eye view of the ecological biotope water purification system according to the third embodiment FIG. 13 of the present invention

FIG. 15 is a plan view of the Ecology Type A.

FIG. 16 is a cross-sectional view of the Ecology Type A.

FIG. 17 is a plan view of the Ecology Type B

FIG. 18 is a cross-sectional view of the Ecology Type B of FIG. 17.

FIG. 19 is a side view of the gabion and the screen filtering apparatus of the present invention.

FIG. 20 is a wire mesh layout inside of the screen filter device of FIG. 19.

FIG. 21 is a plan view showing first step of the pond composting method for each lane of the ecological biotope water purification system according to the present invention.

FIG. 22 is a plan view showing second step of the pond composting method for each lane of the ecological biotope water purification system according to the present invention.

FIG. 23 is a plan view showing third step of the pond composting method for each lane of the ecological biotope water purification system according to the present invention.

FIG. 24 is a plan view showing forth step of the pond composting method for each lane of the ecological biotope water purification system according to the present invention.

FIG. 25 is a plan view showing the final step of the pond composting method for each lane of the ecological biotope water purification system according to the present invention.

FIG. 26 is a cross-sectional view of A-A in FIG. 25.

FIG. 27 is a cross-sectional view of B-B in FIG. 25.

FIG. 28 is a cross-sectional view of C-C in FIG. 25.

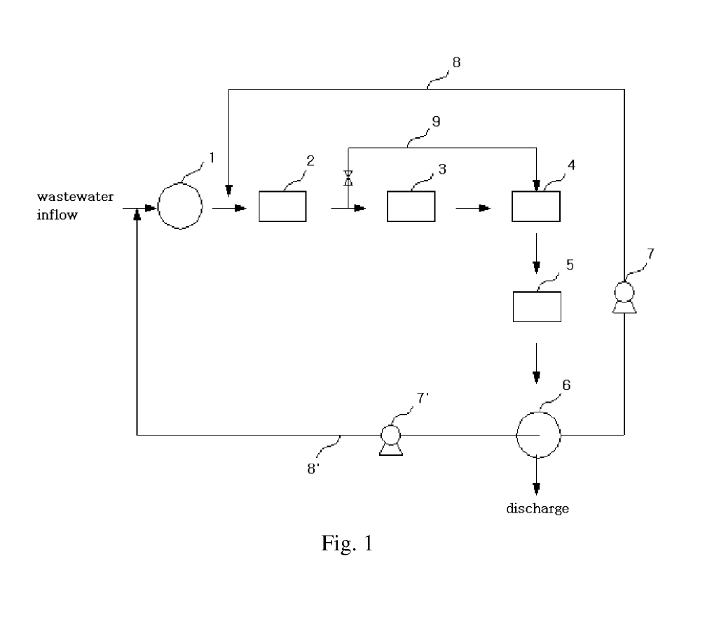

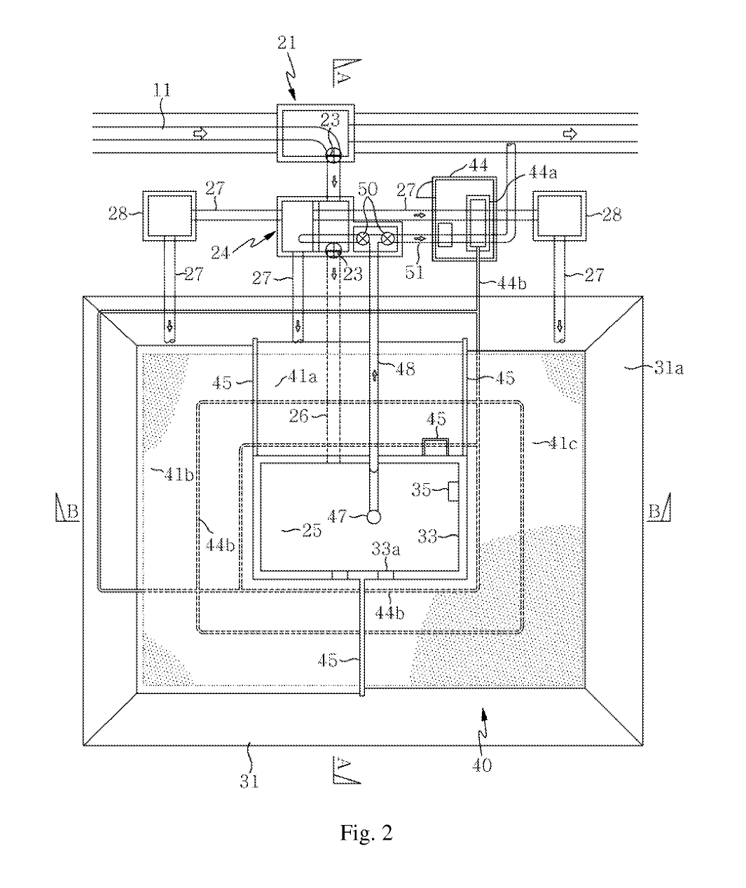

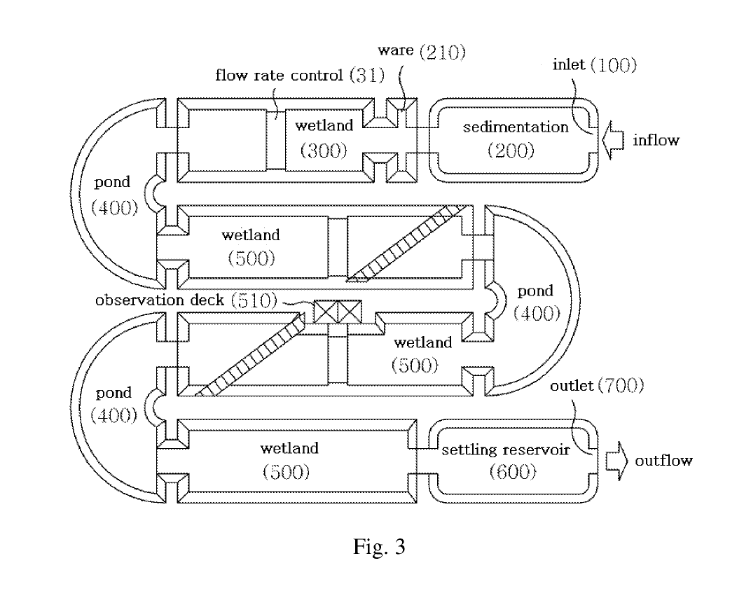

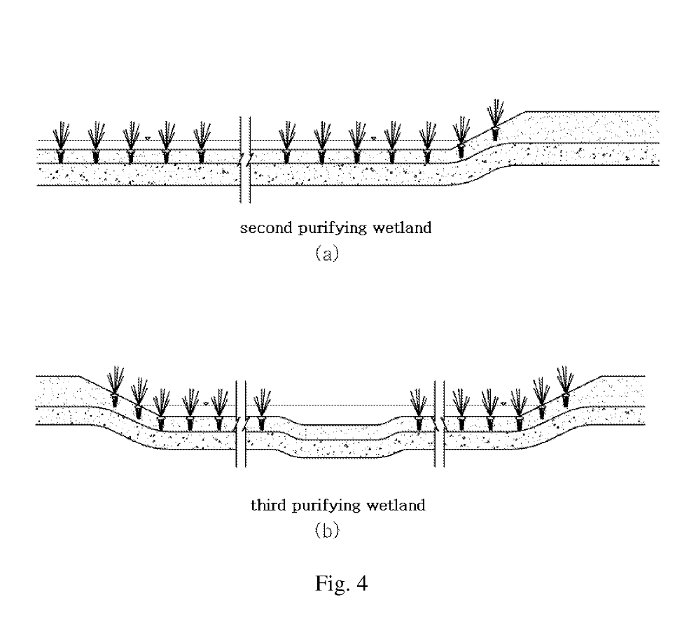

### DETAILED DESCRIPTION OF THE PREFERRED EMBODIMENTS

Hereinafter, the embodiments of the present invention will be described in detail accompanying the drawings.

For a reference, the embodiments of the present invention described below is merely illustrative, it should not be interpreted as the technical scope of the present invention limited to the below embodiments.

### Example 1

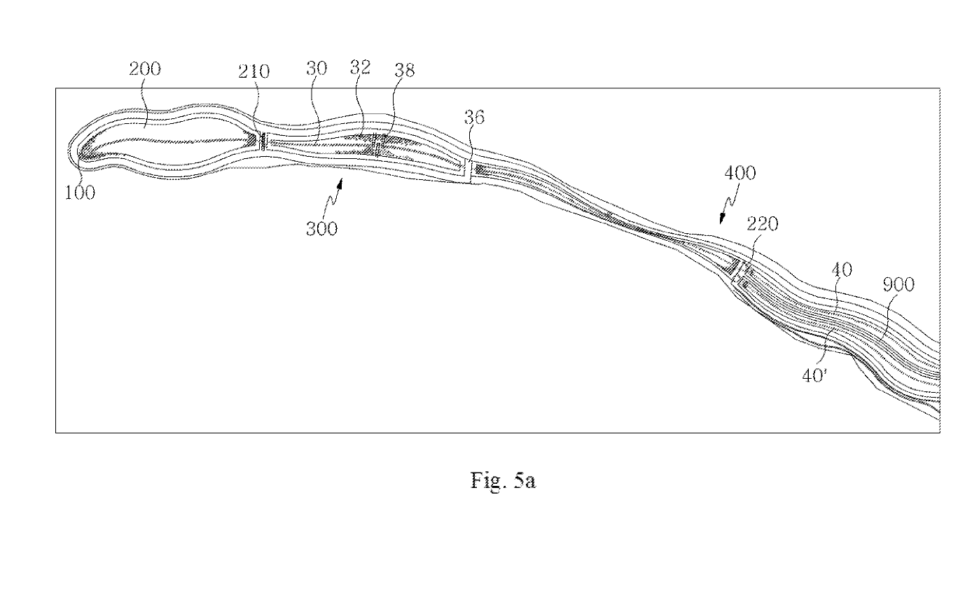

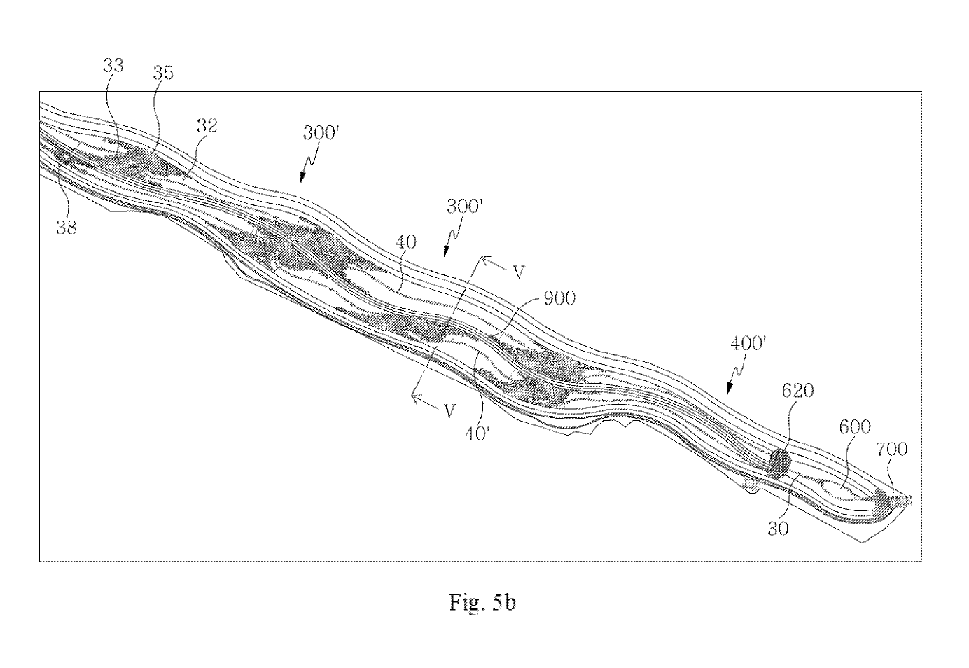

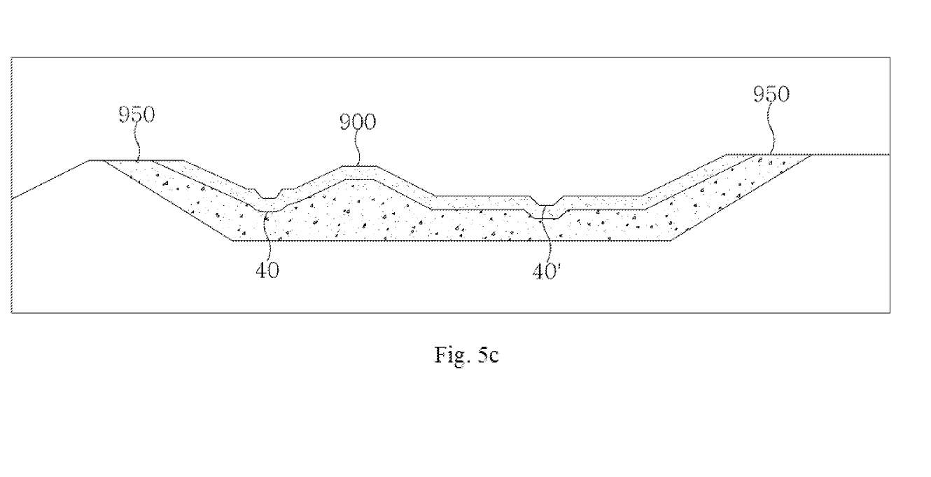

First, referring to FIG. 5a to FIG. 7b, the ecological biotope water purification system using multi-cell and multi-lane according to the first embodiment of the present invention is described.

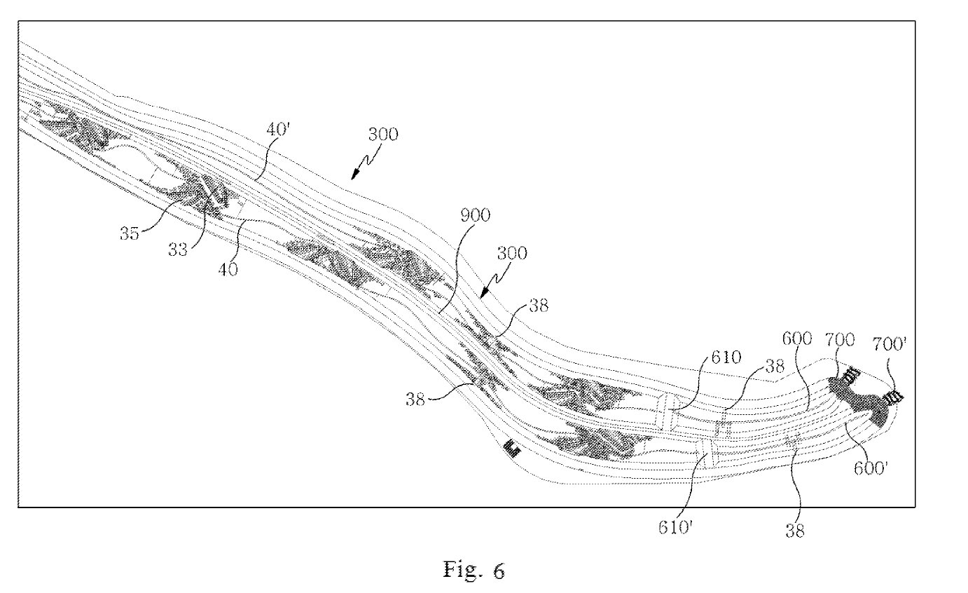

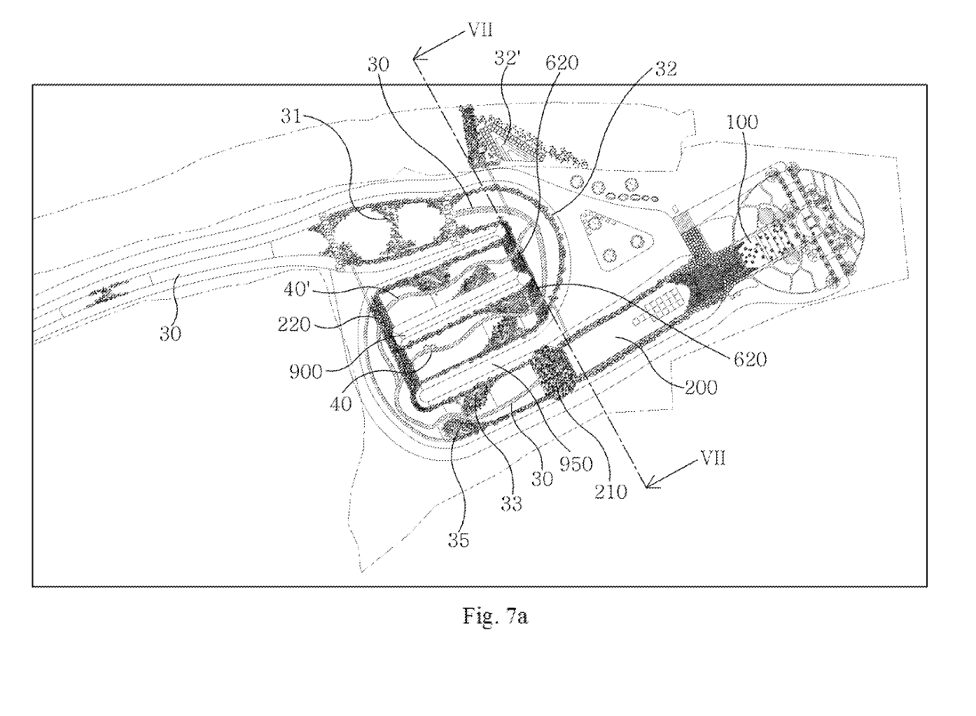

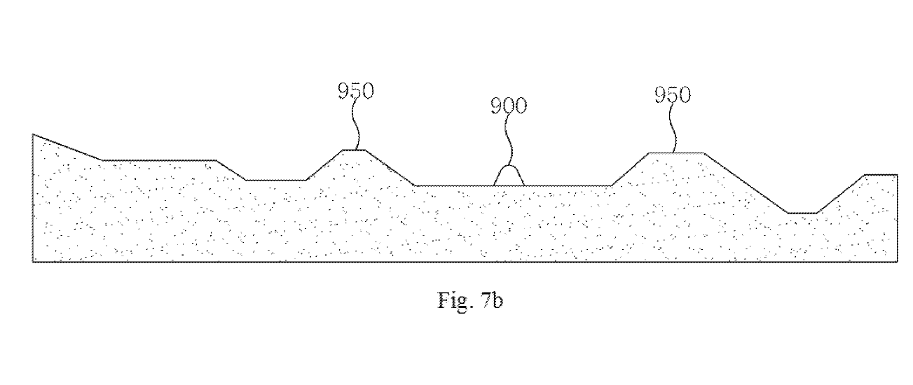

FIGS. 5a and 5b are the plan view of first embodiment of an ecological biotope water purification system according to the present invention. FIG. 5a is a plan view of upstream of the ecological biotope water purification system. FIG. 5b is a plan view of downstream of the ecological biotope water purification system. FIG. 6 is a plan view showing the different confluence of each lane of the ecological biotope water purification system according to the present invention. FIG. 7a is a plan view showing each lane having both straight and curve section of the ecological biotope water purification system according to the first example and second modified example of the present invention.

First, as shown in FIG. 5, the multi-cell and multi-lane of the ecological biotope water purification systems of the present invention consists of; a sedimentation pond (200), which is in contact with the inlet (100), the inlet side (300) wetland and pond (400), and outflow side wetland (300′) and pond (400′), and the outlet (700) in contact with the settling reservoir (600).

In case of the proposed site for composing the wetland and pond has narrow width as the third conventional technology, the sedimentation pond (200) and wear (210) are formed along one channel (30). In some cases, the gate dam (36) or the fixed dam could be formed in some places, and the screen filtering means (38) could be formed between the gabions. The embodiment of the gabion will be described later.

However, in case of the width significantly widening along the downstream site, two or more lanes i.e. branches (40, 40′) are distributed through the distribution unit (220), and both branches aft separated by a small dike (900). Typically, the distribution unit (220) consists of the same height of the embalming panels. The first branch (40) and second branch (40′) have significant difference in height or width, either one side height of the distribution adjusts higher (or lower) for controlling the water quantity.

According to the overall width of the proposed site, the overall width is suitably divided for each lane, but it is not necessarily split evenly. As shown the left edge in FIG. 5b, the first lane has installed the ecological water purification media (33, 35) to have relatively wider pond and shallow, and it is possible that the second lane has simply installed gabion only to have relatively narrow and shallow pond.

Concerning the interval of the ecological water purification area, the slope of each lane is considered according to the proposed site. If the slope is steep, the interval of the ecological water purification media is possibly installed relatively narrow.

Now, the downstream of the proposed site to be narrow (right end of FIG. 5b), both lanes merges to form a joining portion (62) as same forming of the distribution unit (220). Continuously, the normal channel (30) is connected and finally, an outlet (700) leads to a settling reservoir (600).

FIG. 5c is a cross sectional view of V-V in FIG. 5b. Largely, the ecological biotope water purification system using the multi-cell and multi-lane of the present invention could be installed between the main stream of river and the terrace land on the river for treating the incoming flows, such as the rainfall or wastewater. As shown in FIG. 5c, the main stream of the river is located on the left side, the terrace land of the river is located on the right, the middle left side has formed the first branch (20) of the first lane, the middle right side has formed the second branch (20′) of the second lane as bounded by a small dike (900).

FIG. 6 shows the first modified embodiment of the present invention. The modified example shows that it might be inappropriate for some reason to have the height difference between the first lane and the second lane and the joined division (600). The first line and the second lane are flowing to each settling reservoir (600, 600′) through the separated wear (610, 610′). It is possibly confluence to the main stream through the outlet (700, 700′).

On the other hand, FIG. 7 shows that the second modified example of the first embodiment of the present invention. The modified sedimentation (200) leads to the channel (30) on the curve through the ware (210). The distribution unit (220) is divided into the first lane (40) and the second lane (40′). They are re-joined to the joint division (620) and connected the curved channels to be single channel (30). Thus, the ecological biotope water purification system using multi-cell and multi-lane of the present invention is possibly combined the main stream of the river (30) and the branch stream (40, 40′), each other according to the geographic situation along the straight line and curved line. Thus, it is possible to keep the natural shape of the land while enhancing the efficiency of the land availability to provide the wetland and pond for purifying a contamination source.

FIG. 7a is a cross sectional view of VII-VII in FIG. 7b. The structure shows that the flowing stream from the sedimentary pond (200) located the most left leads to the original channel (30) through the first branch (40) and the second branch (40′).

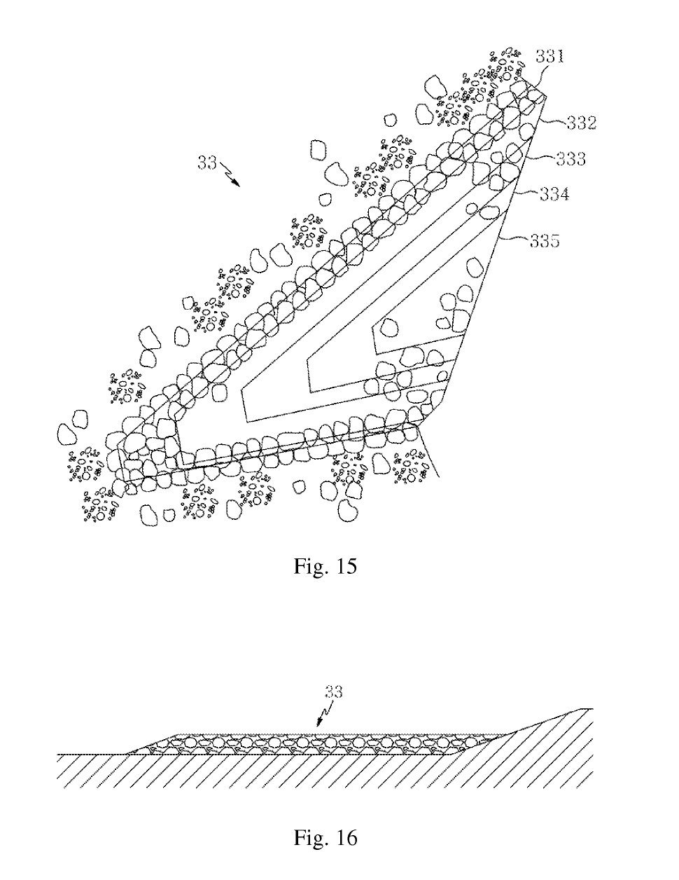

Now, aforementioned ecological water purification media (Sustainable Structured Media: SSM) will be described with reference to FIG. 15 to FIG. 18.

FIG. 15 is a plan view of the ecology type A. FIG. 16 is a cross-sectional view of the ecology type A of FIG. 15.

The ecology type of the ecological water purification media is consisted of the one large size stone layer (A layer; 331) on the outside and four of the wire-mesh basket layers (B floor-E layer; 332-335), filled the natural material internally, the total is five layers.

The outer layer (A layer) of the large sized stone (φ150˜200 mm) is made by stacking, for example if the wetland width is greater than 15 m, the slope is 1:2, less than 15M, the slope is 1:1.5 to be the smooth slope.

From B layer to E layer, the stone containing cage is fabricated to fill the natural stone material inside the cage. For instance, the shape of the stone containing cage between the front surface contacting the water stream and the inclined surface of the wetland has an angle of 30°, the rear surface and the inclined surface of the wetland has an angle of 120°. The stone containing cage for separating each layer, it will be placed with the same interval according to the design manual. The contacting surface with the wetland is fabricated to fit the composing slope of the wetland. Accordingly, the slope angle (1:2, 1:1.5) is produced. The height of the stone containing cage is, for instance, set 50 cm placed on the wetland, for instance, set 70 cm placed on the pond.

The natural material filled in the stone containing cage is considered the efficiency of the water purification, the ecological effects. For example, the <Table 1> illustrates the standard mixture ratio to fill the stone containing cage. In other words, the inner cage contains a number of smaller sized inner filler media, and towards the outside, the cage contains larger sized of filler material. From B layer to E layer, the riparian vegetation is planted on the upper part of the composed cage.

TABLE 1

| | Natural | Natural | Natural | Natural | |
|---|---|---|---|---|---|
| | material | material | material | material | |
| type | B Layer | C Layer | D Layer | E Layer | size |
| a | 10% | 20% | 30% | 50% | small |
| b | 40% | 30% | 50% | 40% | Medium |
| c | 50% | 50% | 20% | 10% | large |

Referring to FIG. 5a, it is preferable to add the handmade SSM (33, 35), additionally, the seated type of the ecotype water purification media (SSM) (32). The seated type SSM is placed in the water of the wetland that can be expected the water purifying effect, due to the physical activity and the biological effects for arranging the natural stone, large-sized stone, gravel, etc. To compose the habitats of the various benthic invertebrates and fishes, it is possible to create the riverbed composition by placing particle size increasing from sand to pebbles or huge rock. In addition, the ecotype water purification media, seated type has lower physical habitat diversity, it can be composed the ecotype water-cave, which is an insufficient habitat by placing the large-size natural stone for withstanding the wash-off wave, and subsequently installed for structural diversity and ecotype water purification media seated type used to remove BOD, SS by the method of gravel contacting oxidation.

The structure of the ecotype water purification media seated type is formed natural stones (for example; 30×40×50 cm), large-sized stone (φ100˜200 mm), and gravel (440 mm) for mainly using ingredients.

For example, the riverbed is placed three natural stones in area of 10 m², and a large-sized stone 0.4 m³, gravel spread on the marsh floor about 0.3 m³. When the seated stone is piled, considering the ecology aspect to generate a lot of pores, while stacking overlapped to prevent the loss of stones by washing off.

The seated stone type SSM is added to provide the habitats, activity, rest and shelter for the aquatic insects. It can be used as a medium to provide food for the growth and survival that can act as an important factor. It is possible to compose a variety of underwater conditions. In addition, the attached algae are grown on the surface of stone. To inhabit the herbivorous aquatic insects such as mayflies under the rock bottom and in the stone pores, the rock should be stacked to widen the surface area and porous. In addition, the boulder piling inside the wetland makes the various water depths and velocity and has the effect of diverse biota.

The ecological water purification media seated-stone type purifies the river water flow-passing through the gravels. The inorganic components of the pollutant contained in the river water, such as the sand, sludge will be precipitated by physical action, the organic matter is reacted with the microorganisms on the surface of the gravel.

In addition, the ecological water purification media seated-stone type creates the natural streams of the landscape, improve the riparian landscape, prevent the lakeshore erosion by water stream, and improving the lakeshore stability by slowing down the flow rate.

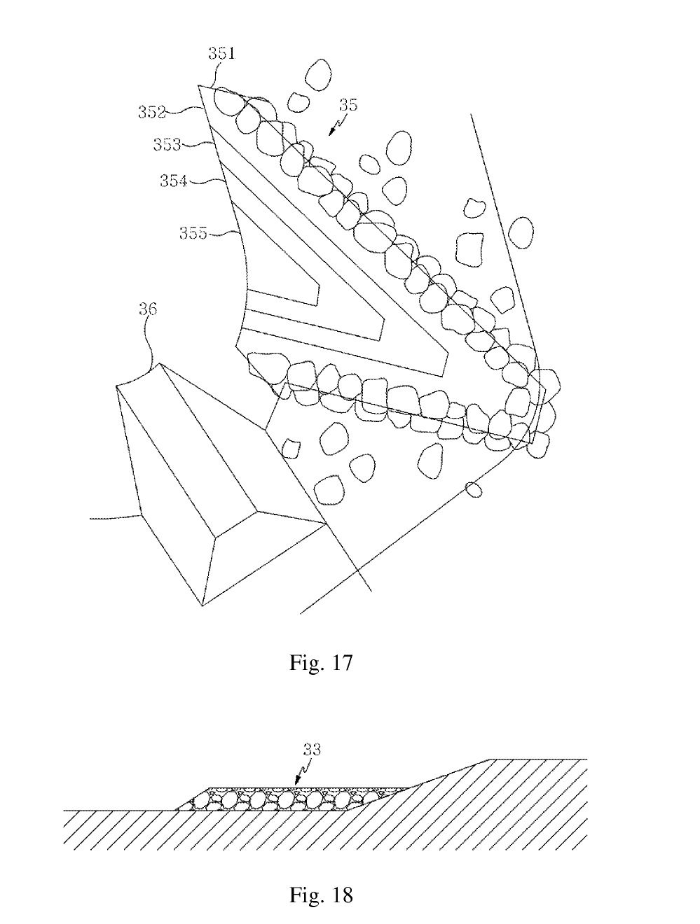

On the other hand. FIG. 17 is a plan view of the ecological handmade, B type, and FIG. 18 is a cross-sectional view of the ecology B type of FIG. 16.

The ecological handmade B-type is suitable to be formed one pond and one set of two sides SSM (33, 35; 43, 45). As shown in FIG. 5, the ecological handmade B-type is the linear stream.

In other words, the upper part of the pond composed by the gated dam is installed the first formulation SSM (33) and the second formulation SSM (35) to cross each other. If the SSM is installed only one side, the water-shore erosion is occurred due to the hydraulic problem or one side bias phenomenon is occurred due to the stream. As a result, it is possible to solve the problem of efficiency reduction of the water purification.

Particularly, it is also possible to apply a different formulation of SSM for the slightly bent river, no perfect linear, no curvy. In other words, FIG. 15 and FIG. 16 are the A-type homemade, and it is possible to consider the handmade of FIG. 17 and FIG. 18. Also, it is possible to create vertical contacts of water shore by considering the geographical characteristics.

In addition, the specification of this B-type formulation of SSM is adjustable depending on the width of wetland and considering the efficiency. Basically, the following criteria apply to be standard. However, these are merely exemplary embodiment of the invention. It is possible to alternating the specification depending on the circumstance.

As shown in drawings, the multi-cell and multi-lane of the ecological biotope water purification systems according to the present invention composes the sedimentation pond (200) and/or the settling reservoir (600) and a plurality of the screen filtering means and gabion (38) for purifying water and fishing is available.

In other words, the marsh (300) and a sedimentation pond (200) and/or settling reservoir (600) are able to purify the water. The ends of paired gabions (38) are overlapped in the transverse direction for purifying water. Between the overlapped pair of gabions, the screen filter means (150) is installed for filtering the suspended particles contained in the water and providing the fishing path.

In addition, the ends of paired gabions of the wetland are overlapped in the transverse direction for purifying water, filtering the suspended particles and providing the fishing path. It is possible to provide more screen filtering means between the overlapped pair of the gabions.

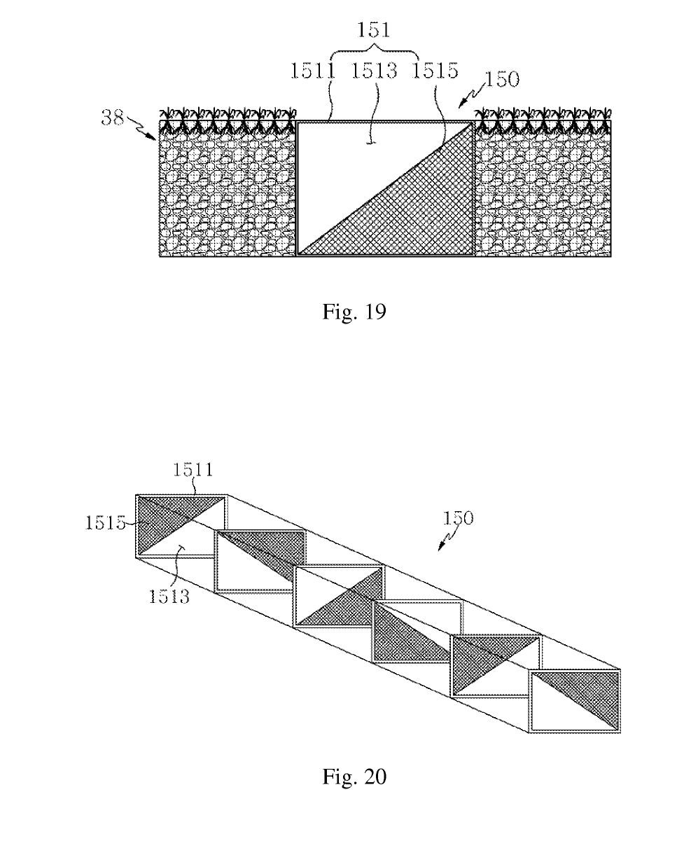

As shown in FIG. 19, the gabion (38) installed in the sedimentation composes two separated rows of the wire-mesh container filled with the large-sized stones and a lot of gravels. The two rectangular wire-mesh cages are connected together to be a long cross-section of a rectangular shape for stacking along the width direction with a certain separated distance.

Here, each end of the gabion (38) is connected to both inner side of the sedimentation and the other end is connected to provide a drainage and a fishing trail. Thus, a certain portion of the gabion is overlapped.

In addition, the upper surface of the gabion (38) is provided the fixed notice of vegetation mat (number is omitted) to compose more environmentally friendly.

It is preferably composed the screen filtering means and the wire mesh gabion made of rust-free stainless steel to protect the water quality from the wire material.

The screen filtering means (150) is placed between the above gabions (38). The overlapped portion has connected each other for purifying the water and forming a fishing trail. A plurality of screen filters being partially formed a rectangular shape is placed with a regular intervals, preferably about 10 cm for filtering the suspended particles and pollutants.

As shown in FIG. 19 and FIG. 20, the screen filtering means (150) is installed between the gabion (38), and the screen filter frame (1511) formed rectangular shape. A screen filter element (151) has formed that; the inner side of the screen filter frame (1511). has split into two portions diagonally, one space portion formed a hole path to pass the fish through (1513), and the other side formed a mesh screen portion (1515) for filtering impurities. A “u”-shaped guide bar frame is welded on both surfaces of the gabion (38), so that the screen filter element (151) is able to attach/detach to the gabion (38).

As shown in FIG. 20, it is preferable to install the screen filtering member (151) to filter the suspended particles and pollutants effectively. The filter screen (1515) is placed to avoid a duplicated position.

### Example 2

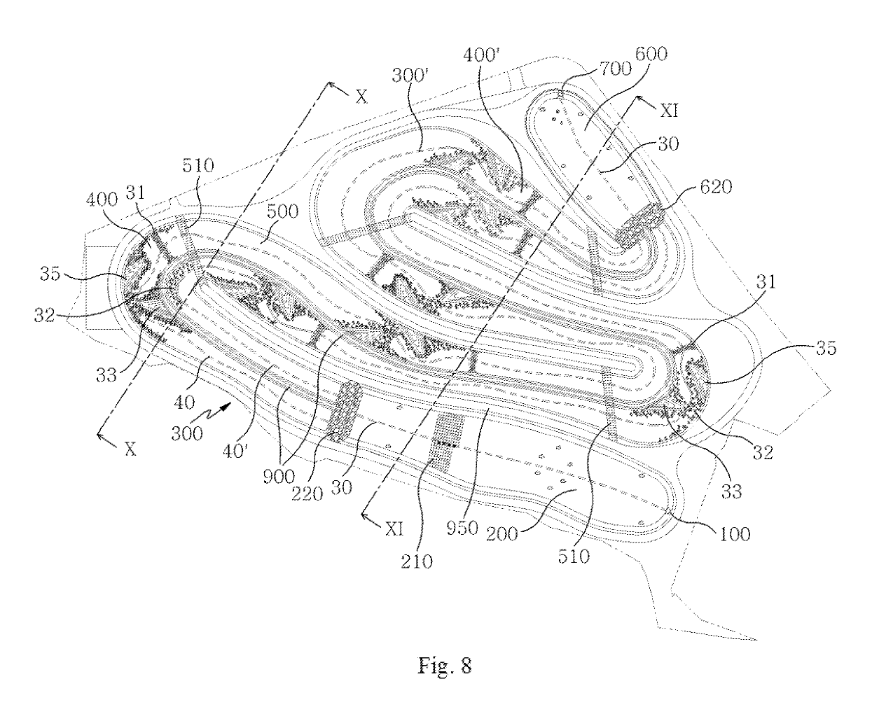

Hereinafter, referring to FIG. 8 to FIG. 12, the multi-cell and the multi-lane of the ecological biotope water purification system according to the second embodiment of the present invention is described.

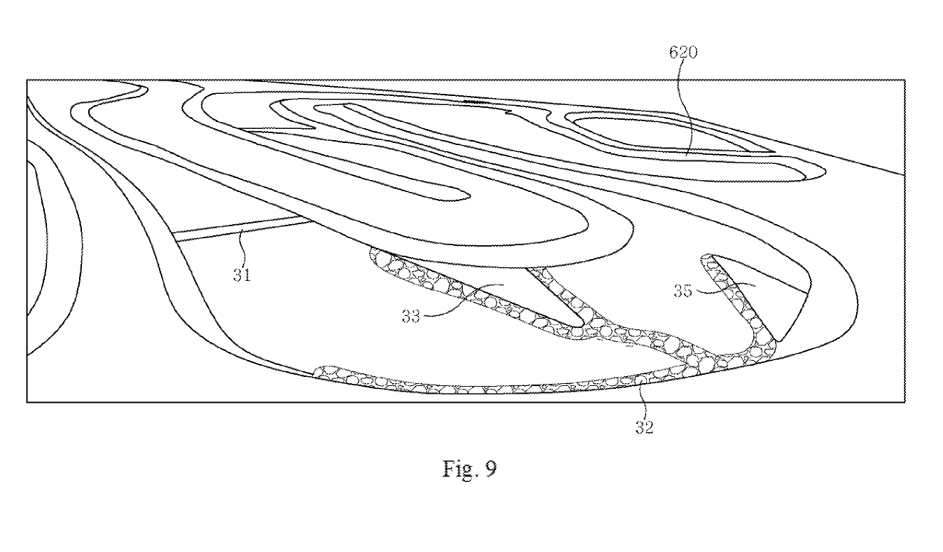

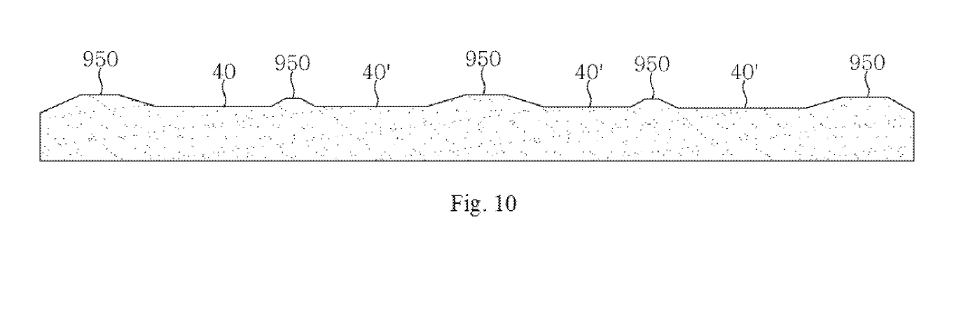

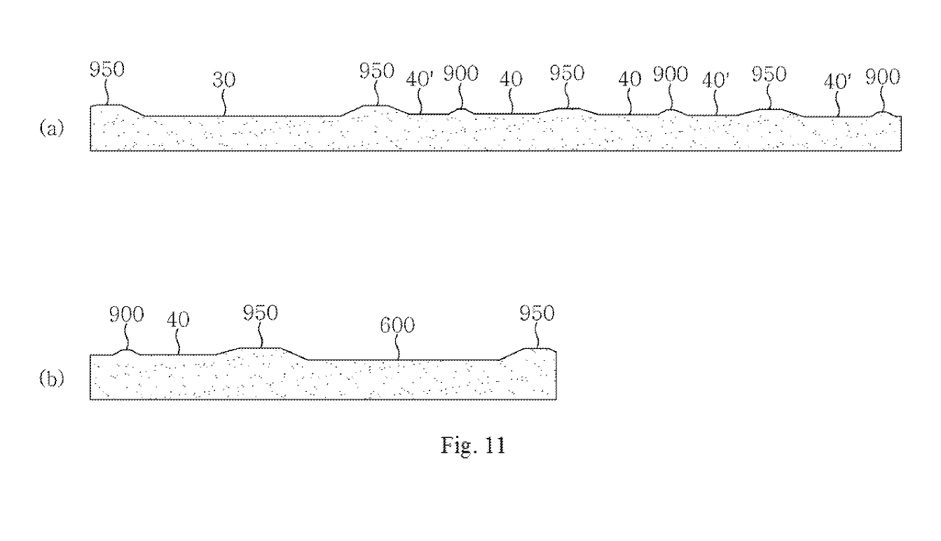

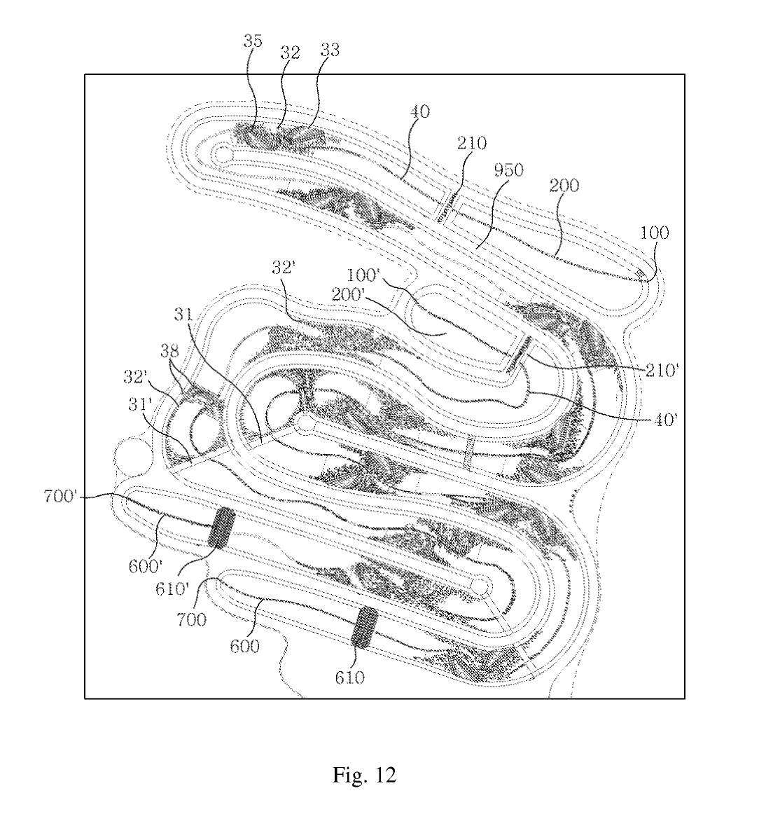

FIG. 8 is a plan view showing each lane forming meandering shape of the ecological biotope water purifying system according to the 2nd embodiment of the present invention; FIG. 9 is a bird eye view of the ecological biotope water purifying system according to the second embodiment FIG. 8; FIG. 10 is a cross-sectional view of X-X in FIG. 8; FIG. 11 is a cross-sectional view of XI-XI in FIG. 8; FIG. 12 is a plan view showing each lane formed the meandering shape with the sedimentation pond and the settling reservoir of the ecological biotope water purifying system according to the present invention.

As shown in FIG. 8, the biggest feature is that; contrary to the first example, a stream, which is continuously composed the wetland and the pond is a curvy type stream, not a straight line stream.

As shown in FIG. 8 to FIG. 11, the example also consists of the inlet (100) is contacted with the sedimentation pond (200), inlet side wetland (300) and a pond (400), the second wetland and outflow side wetland (300′) and a pond (400′), and the outlet (700) in contact with the settling reservoir (600).

More specifically, the upper stream is connected along the single channel (30) through the sedimentation pond (200) and ware (210) to the distribution unit (220) being divided more than two lanes, i.e. the branches (40, 40′). Both branches are separated enough by the small dike (900).

Thus, each lane has follow composition: the wetland (300) is consisted of the ecological water purification media (33, 35) or ecologically arranged stones (32), and the pond (400) formed ecological check-dam (31) or gated dam, which are composed alternatively. In some cases, the screen filtering means is added between the gabions (FIG. 5a, 38).

In some cases, a second marsh (500) may have formed the observation deck (510). And, the wetland and pond are repeated to compose until the outflow side wetland (300′) and pond (400′). In front of the settling reservoir, the lines are joined by the joint unit (620) and connected to the settling reservoir (600) through a single channel (30).

In this embodiment, the first branch (40) and the second branch (40′) are formed the curvy river, so there are difference in the total length of the branches. Therefore, the number of the ecological water purification media, or other media, and in gabion are varied. Preferably, the outside lane has formed primarily the media and gabion.

However, the intervals of the ecological water purification media is composed according to the target site by considering the slope of each lane.

The example of FIG. 9 is the actual composition of this embodiment, the joining unit (620) is formed as the ditch type, an administrator or an observer is moveable to joint unit. The fixed dam (31) is formed somewhat lower than the seat-stone type ecological water purification media (32). The outermost layer of the ecological water purification media (33) is connected to a significantly large size of pumpkin stone. While the pond is composed, some extent, the passage for the observer is the formed. Therefore, the wetland and pond are formed as a one-to-one repetition. The relationship of the ecological water purification media and the wetland is not necessarily followed the natural rule.

FIG. 10 is a cross-sectional view of X-X line in FIG. 8 that is shown the site of the present invention is formed a levee road (950) between the outer banks of the river and the small dike (900) between the first branch (40) and the second branch (40′).

FIG. 11 is a cross-sectional view of XI-XI line in FIG. 8 that is shown the site of the present invention is formed a levee road (950) between the outer banks of the river and the small dike (900) between the first branch (40) and the second branch (40′).

On the other hand, FIG. 12 is illustrated the modified second embodiment of the present invention. The modified example is composed the inlet (100, 100′), which is the starting point of the first lane (40) and the second lane (40′), the sedimentation pond (200, 200′) formed separately in different location, the outlet (700, 700′) which is the end point of the first lane (40) and the second lane (40′), the settling reservoir (600, 600′) formed separately, the following wares (210, 210′; 610, 610′) and the fixed dam (31, 31′).

For reference, FIG. 12 of an embodiment shows the main lane, which has composed the first lane (40) formed longer and wider than the second lane (40′). Thus, the first lane (40) side is formed the pervasive type ecological water purification media (33, 35) and the seated type ecological water purification media (32). The first lane has relatively large and significant wide wetlands and ponds. A second lane i.e., an auxiliary lane (40′) has relatively composed smaller wetlands and ponds, which has formed by the gabion (38′) and seated type ecological water purification media (32′).

### Example 3

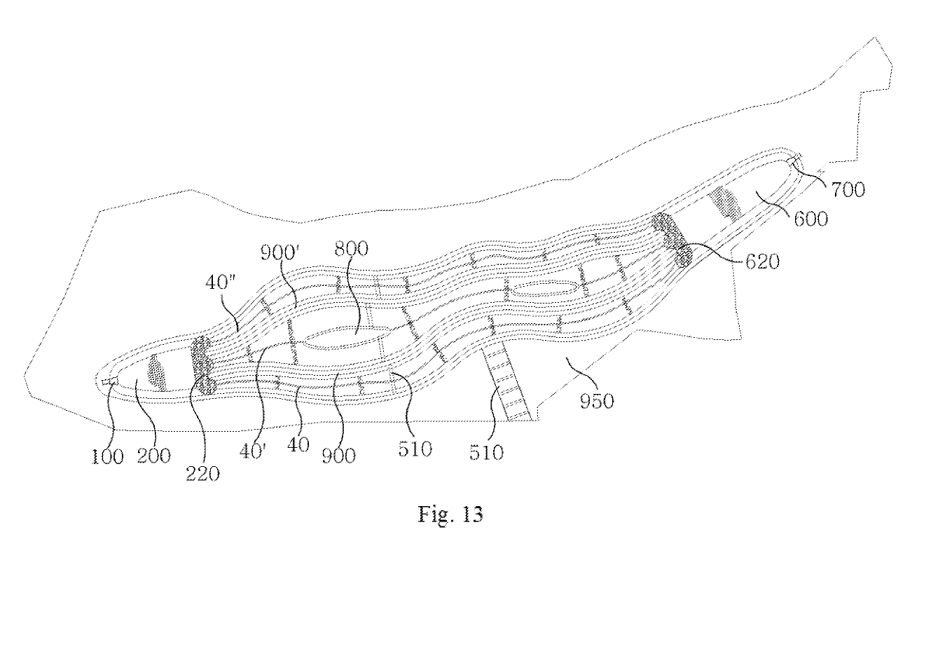

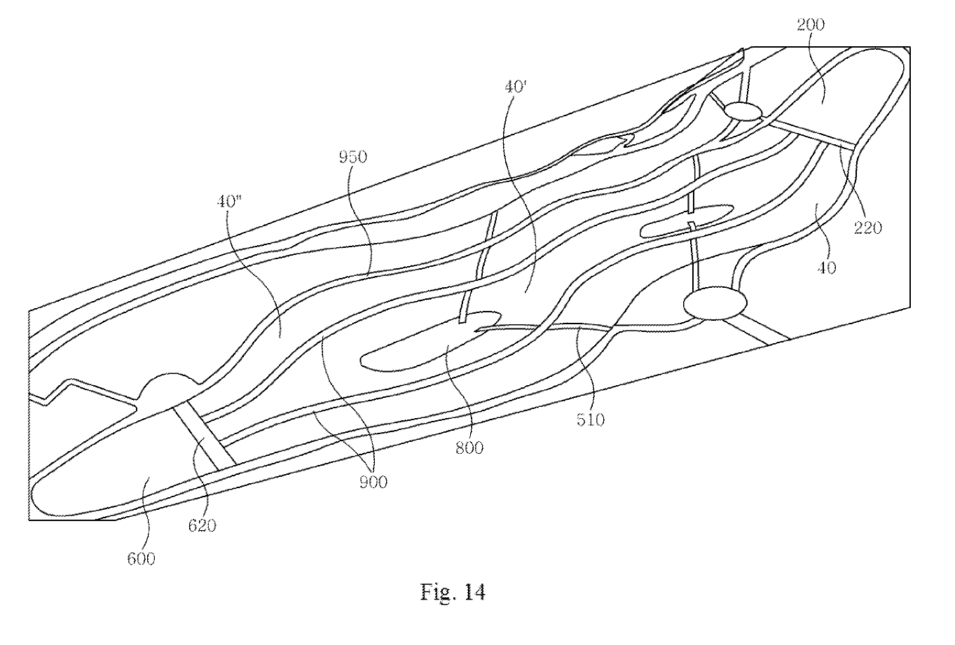

Now, referring to FIG. 13 to FIG. 14, a third embodiment of a multi-cell and multi-lane of the ecological biotope water purification system according to the present invention is described.

FIG. 13 is a plan view showing third embodiment of the ecological biotope water purification system with three lanes according to the present invention. FIG. 14 is a bird eye view of the ecological biotope water purification system according to the third embodiment FIG. 13 of the present invention.

In this embodiment, the biggest feature in contrast to the first embodiment as shown in FIG. 13 is that three branches is three-lane system.

As shown in FIG. 13 to FIG. 14, also this embodiment is composed that; the inlet (100) contacted with the sedimentation pond (200), the first branch (40), the second branch (40′) and the third branch (40″) and distinguishing the first small embankment (900) and the second small embankment (900′) and the outlet (700) contact to the settling reservoir (600).

More specifically, the upper stream has divided into the three lanes (40, 40′, 40″) i.e., three branches (40, 40′, 40″) from the sedimentation pond (200) through the distribution unit (220). Both tributaries are separated enough by two small dikes (900, 900′).

Particularly, in case of the second lane, several mid-islands (800, 800′) are composed in the middle of lane, the external levee road (950) connected through the observation deck (510), for the case of the small dike some extent of the width left to take advantage of the trails, and the maintenance, sightseeing that make use of the characteristics of the features.

(pond composing method in each lane for SSB system according to the present invention)

Finally, referring to FIG. 21 to FIG. 28, an example of the pond composition process in each lane of the ecological biotope water purification system according to the present invention will be described with reference.

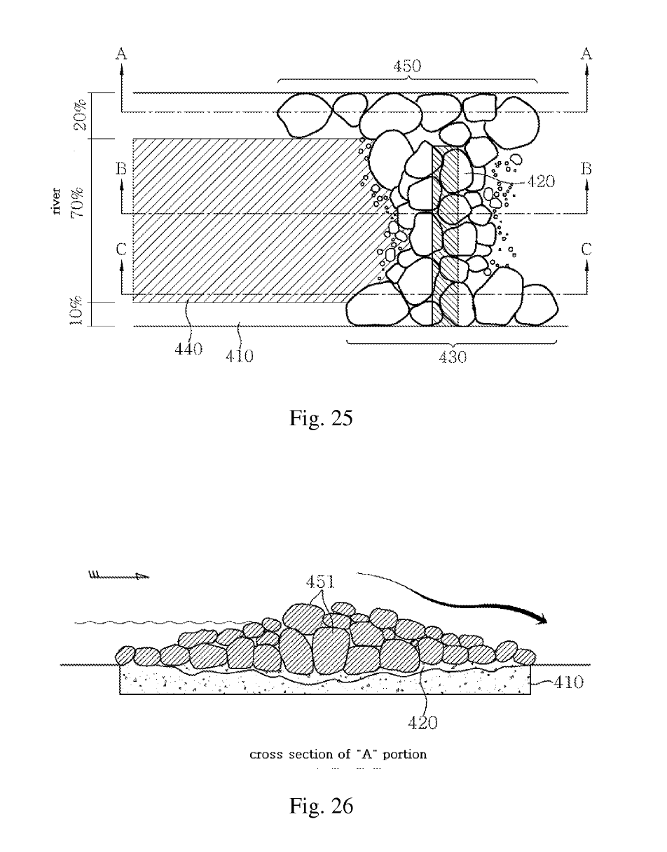

FIG. 21 to FIG. 25 is the plan view of the pond composing process in each lane of the ecological biotope water purification system according to the present invention showing the first step, second step, third step, the fourth step and the final step. FIG. 26 to FIG. 28 is the cross sectional view of A-A, B-B in FIG. 25, and C-C in FIG. 28.

Referring to FIG. 21 to FIG. 25, the pond composition process in each lane of the ecological biotope water purification system according to the present invention will be described with reference. As shown in FIG. 21, the mortar layer (420) as a base is formed on the original floor bed (410) left about 20% on one side of the river.

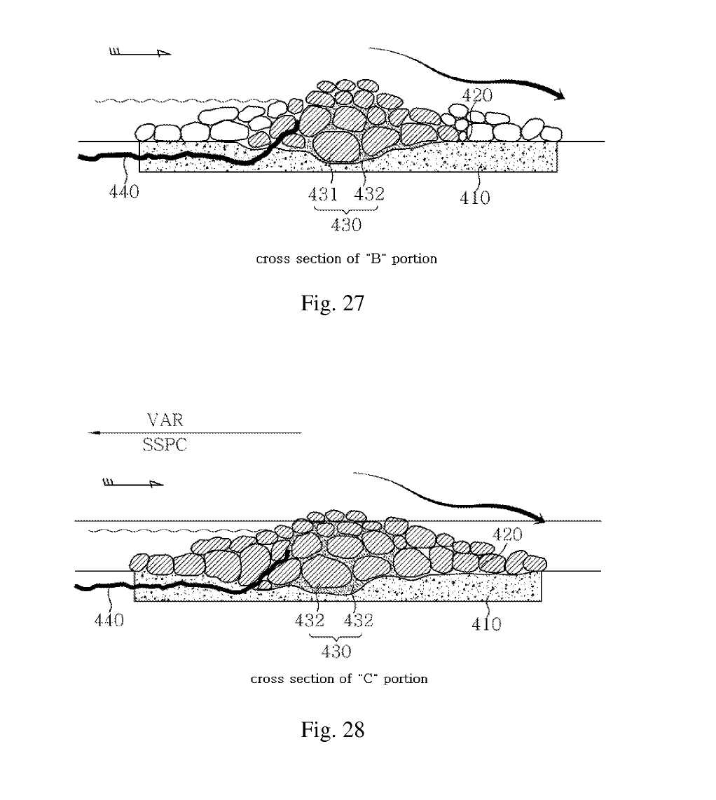

At this point, the structure of the basic mortar layer (420) is suitably formed by considering, underwater bed structure, slope, hydraulic power, water supply of each stream. As shown in FIG. 27 and FIG. 28, when viewed from up-downstream direction as the first step, the center has formed deeper than the original riverbed. The basic mortar layer (420) forms possibly even width (see FIG. 25) viewed from the up-downstream direction, it is preferable to extend toward the riparian.

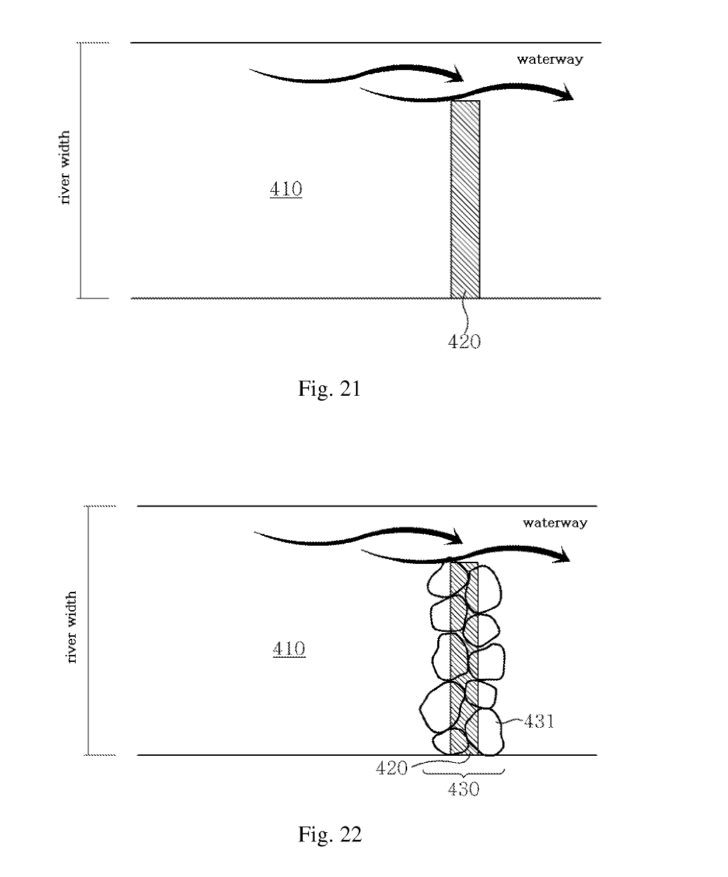

Next, as shown in FIG. 22 shows the second step, the natural stone stacking and the fixing phase is progressed on the basic mortar layer (420) i.e., as shown in the FIG. 27 and FIG. 28, the natural stone (431) placed on the basic mortar layer (420), and subsequent stacking of the natural stone is also fixed on the upper mortar layer (432), and after the natural stone fixed to be formed the fixed layer (430).

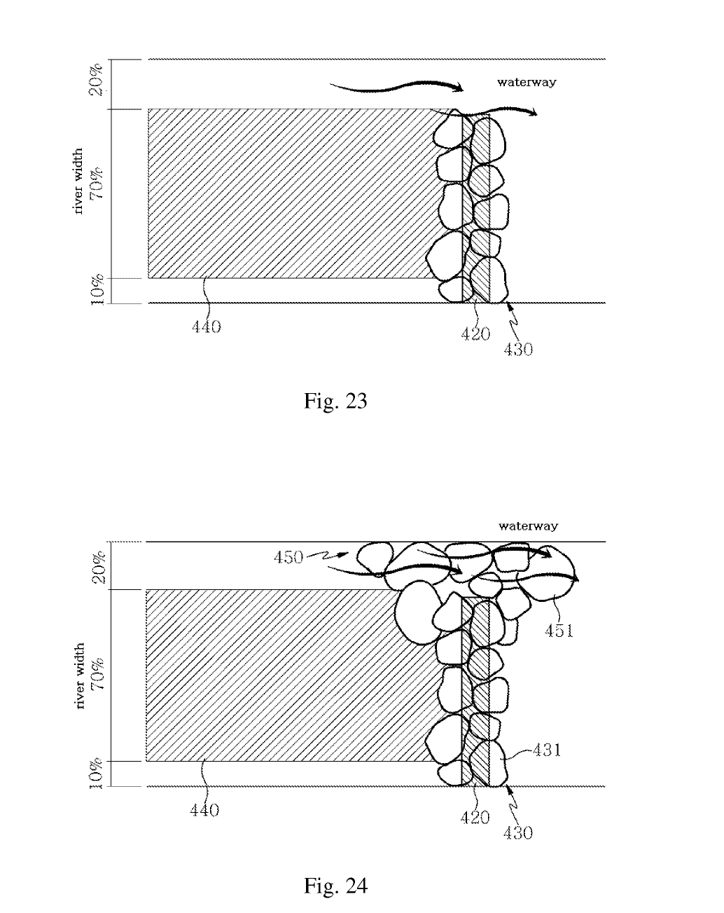

Continue to the third step, as shown in FIG. 23, at least some sort of natural stone fixed layer (430) is formed on the upstream of the SSPC unit (440); the non-friendly environmental structure, such as a concrete does not needed on the upper stream riverbed; and some of the river-water flow through for roots down of plants; such as the extremely nature-friendly way forms a waterproof layer; thus, a ‘small’ (pond) is formed.

The present inventor has disclosed that Republic of Korea, Patent No. 1,079,051 (the ecological water purification permeability control (SSPC) system) are described in detail of the SSPC unit (440).

The present inventor has disclosed the first embodiment of the Republic of Korea, Patent No. 1,079,051 No. 1 Permeability Control Layer. For the authentic waterproof of the original ground floor (410), about 10 cm thick Bentonite mat can be used to combine the Bentonite and waterproof sheet; then, about 50 cm of soil layer is formed over the Bentonite mat to provide the habitat for the aquatic plants; for the Bentonite mat, non-woven fabric, such as a cotton or fiber layer is coated with certain thickness over about 2-3 mm thin plastic sheet; the Bentonite is attached between and over the fiber layer, then overlapping the thin plastic and woven fabric again; In other words, a natural acid sodium Bentonite is filled between the woven and non-woven fabric, then needle-punched to fix the moving of Bentonite powder to be fixed mat-type structure; the whole material is uniform; the transformation of the shape and dimension should be free; easy to construct in the flexion area so that it has to be flexible and expandable; Bentonite compaction layer must be able to seal thread cracks or pores of the concrete by adequate expansion of hydration; for reference, the Bentonite reacts with the water to expand 13˜16 times than its original volume and absorbs water five times than its own weight; by doing so, a strong waterproof layer is formed; at the same time, it does not cause chemically adverse effects on the soil, so the change of formation does not affect the waterproof layer due to adhesion; without any chemical adverse effects on the soil, it has a merit that there is no suppression for plant root growth; the high-performance of Sodium Bentonite kernel used in the waterproof is the same material as Montmorillonite, which is contained at least 85% or more; for reference, the vinyl fabric is used a woven tarpaulin having a certain width with the weft and warp, but it is not limited to the woven vinyl; what thickness the plastic sheet should have for the authentic waterproof; if the plastic sheet is too thick, the growing of plant root is blocked. It can be blocking the contaminants. However, it is preferable that the plant roots should penetrate the plastic sheet to grow; the plastic has to be biodegradable material, it is desirable to use the decomposable plastic ingredients according to the land becomes stable; The plastic sheet has specified in the KS F 4911, the General sulfur rubber compound is used suitable for polystyrene Sheet (HDPE), but EPDM rubber can be used the asphalt sheet as a special sheet.

The inventor of the present Patent No. 1,079,051, another 2nd embodiment of the SSPC unit (440), a second Permeability Control Layer, also disclosed that about 50 cm thickness of the geo-com layer is located above the original layer (410), and about 50 cm of the soil layer is located above this. The second penetrability control layer of the geo-com used in the geo-com layer; the transverse reinforce wire crosses the vertical reinforce wire to form a reticular sheet having a certain size of pores; this reticular sheet formation is welded to connect with a certain intervals and pulled the sheet to the width direction, then the large number of honeycomb cell-net is formed; The Republic of Korea, Patent No. 834784 has disclosed the Geo-composite structure consisting of a multiple porous cell-wall surrounding the soil particle as the honeycomb type reinforcement; the geo-com has a certain length of polyether material that the transverse reinforce wire crosses the vertical reinforce wire to form a reticular sheet having a certain size of pores; this reticular sheet formation is welded to connect with a certain intervals and pulled the sheet to the width direction, then the large number of honeycomb cell-net is formed; when the room of cell-net is filled with the sand, soil and gravel; the front surface of net has uniformly formed multiple porous without extra process; so that the frictional property is improved, the material is saved and weight is reduced; it has a benefit to easily survive the roots; the construction of the geo-com layer, deploy the geocom and fixed it with pins on the ground to form the cell-net and fill the sand, soil and gravel; As described above, when a geocom layer is formed, the soil improves the high permeability, reinforcement, preventing the soil wash-off, and the wetland plants easily roots down, as shown in the second permeability control layer

The SSPC unit (440) of another third embodiment, the inventor of the present patent No. 1,079,051 No. 3 Permeability Control Layer, has described that; about 5-10 cm of the Bentonite layer is formed above the original soil layer (410) and about 50 cm soil layer formed thereon; In some case, the gravel layer as the natural filter media may be formed above it. The Bentonite layer is prepared to mix with the Bentonite and the mud or clay such as the environmentally friendly materials; More preferably to promote biodiversity, the soil collected from the existing rice paddy or mud is used, if there would be organic materials or waste contained, it will be caused to pollute the water. So, the pollutants should be removed before using the soil or mud; the mud or soil used for Permeability Control is mixed with Bentonite, that has the permeability ratio less than 10⁻⁶ cm/sec; the mud used as a Permeability Control Media should performs the compaction test to obtain the maximum dry density of the hydro containing status for constructing; when there is an anxiety of the ground subsidence, before laying the mud or soil, a nonwoven fabric is laid for reinforcing, the nonwoven fiber has the tensile force of 1 ton per 1 m; After laying and hardening the clay for Permeability Control, the maximum dry density should be more than 90%, with the laying thickness of more than 15 cm.

As shown in FIG. 24 to continue step 4, the large stones (451) are stably placed around the waterway and some small stones placed to fill a large gap for forming the natural style of the ecological corridor (fishing road), and the area of the waterway applies the mortar partially to form a natural style of the fishing road portion (450).

As shown in FIG. 25, final step, applied the mortar for the waterway area and applied the mortar for whole area, the upstream and the downstream are finished to stack the natural stones.

In other words, as shown in FIG. 25 and FIG. 26, in the section (‘A’ section) formed waterway, the large stones are stably placed on the basic mortar layer (420) to secure the natural form of waterway, fishing road, the upstream and downstream stacking the natural stones (in this section is not formed SSPC); as shown in FIG. 25 and FIG. 27, on the basic mortar layer (420) in the middle section (‘B’section), the stacking of the natural stones and the stacked natural stone (431) above the mortar (432) are fixed to each other through the fixing step to form a Natural stone fixed layer (430); The upstream of the natural stone fixed layer (430), the SSPC unit (440) is formed; as shown in FIG. 25 and FIG. 28, the opposite region (‘C’ section) of the waterway formation, also the stacking of the natural stones on the basic mortar layer (420) and the stacked natural stones (431) above the mortar (432) are fixed to each other through the fixing step to form a natural stone fixed layer (430). The upstream of the natural stone fixed layer (430), the SSPC unit (440) is formed. Then, the upstream and the downstream will be finished through the stacking of the natural stones.

Accordingly, in case of composing the ecological river having the fishing roads and rapids, it is possible to construct without blocking the waterway. The natural Ecological corridors can be simply formed through the ‘A’ region; contrary, through the ‘B’ and ‘C’ region, it is possible to form the river-bed some extent on the naturally eco-friendly, at the walk-road of upstream, the natural type ‘small swamp’ is formed; if it is a lot of precipitations, the natural type walk road is over flood to be a riffle. The ecological river having a natural type of riffle is composed in a very simple way.

So far, the process to create the pond is nothing more than an example to compose the swamp and the shallow to be natural style, the width of the SSPC, each lane are variable. In some cases, it is possible to alter the method of laying a mortar layer for fixing the natural stone.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. An ecological biotope water purifying system utilizing structures of multi-cells and multi-lanes of marsh, pond and settler, the system comprising that:
a sedimentation pond (200, 200′) for temporarily storing wastewater inflowing from an Inlet (100,100′);
a marsh (300, 300′) inflowing a primarily treated water, which is precipitated solid contaminants, and discharged from said sedimentation pond (200, 200′), and at least one Multi-level cell composed an open water-surface pond (400, 400′), which is entering the primarily treated water from the marsh,
a settling reservoir (600, 600′) outflow finally purified water by said multi-level cell inflow for temporarily storing through outlet (700, 700′), and
said multi-level cell is consisted at least two of multi-lanes (40, 40′, 40″), each lane has separated by small dikes (900, 900′).

2. The ecological biotope water purifying system according to claim 1, wherein said multi-lane is divided by distribution unit (220) to the sedimentation pond (200) and the small dike (900, 900′) from single-channel (30).

3. The ecological biotope water purifying system according to claim 1, wherein said multi-lane is consisted of three multi-lanes.

4. The ecological biotope water purifying system according to claim 1, wherein said multi-lanes are joined by joint division (620) to be connected settling reservoir (600).

5. The ecological biotope water purifying system according to claim 1, wherein said multi-lanes are composed from the separate sedimentation pond (200, 200′) being divided by said small dike (900, 900′).

6. The ecological biotope water purifying system according to claim 1, wherein said multi-lane is separately connected to each settling reservoir (600).

7. The ecological biotope water purifying system according to claim 1, wherein said multi-cells of the marsh and pond forms S-shape curvatures, repeatedly to comply with the terrain.

8. The ecological biotope water purifying system according to claim 1, further comprising that: a first marsh incoming purified water treated by said multi-level cell being connected to second or more multi-levels, including second marsh (500) composing second or more multi-level cells, which is acting same as the first marsh.

9. The ecological biotope water purifying system according to claim 1, wherein said multi-level cell include at least one of the ecological water purification media (SSM) (32, 33, 35).

10. The ecological biotope water purifying system according to claim 1, further comprising that: at least one of the multi-level cells include a gabion (38).

11. The ecological biotope water purifying system according to claim 1, wherein said multi-level cell includes paired gabion (38) being edge overlapped each other, in transverse direction for purifying water, and a fishing waterway with a filtering means (150) being installed between the overlapped gabion for filtering the floating.
